(19) United States
(12) Patent Application Publication
(10) Pub. No.: US 2024/0417624 A1
(43) Pub. Date: Dec. 19, 2024

(54) METHOD FOR REGENERATING ASPHALT AND/OR BITUMEN CONTAINING DEBRIS

(71) Applicant: Pius Imholz, Schattdorf (CH)

(72) Inventor: Pius Imholz, Schattdorf (CH)

(21) Appl. No.: 18/782,202

(22) Filed: Jul. 24, 2024

Related U.S. Application Data
(63) Continuation of application No. PCT/EP2023/051696, filed on Jan. 24, 2023.

(30) Foreign Application Priority Data
Jan. 25, 2022 (CH) CH000070/2022

(51) Int. Cl. C10C 3/06; C08J 11/06; C08L 95/00

(52) U.S. Cl. CPC C10C 3/06; C08J 11/06; C08L 95/00; C08J 2395/00; C08L 2207/22

(57) ABSTRACT

A method for regenerating asphalt and/or bitumen containing debris, which allows to recycle more bulk material and optionally binding agents.

### CROSS-REFERENCE TO RELATED APPLICATION

The present application is a bypass continuation of PCT/EP2023/051696 filed Jan. 24, 2023, which claims priority from Swiss Application CH000070/2022 filed Jan. 25, 2022, the disclosures of which are expressly incorporated herein in their entireties.

### BACKGROUND OF THE INVENTION

### Field of the Invention

The present invention lies in the field of regeneration of asphalt and/or bitumen containing debris and relates in particular to a method for regenerating such asphalt and/or bitumen containing debris as well as the use of materials regenerated by such a method.

### Description of Related Art

Asphalt and/or bitumen containing debris may for example originate from road construction and demolition. If old roads are dismantled, the resulting excavated material comprises bulk materials such as rocks, slit, sand and the like, as well as asphalt and/or bitumen. In the past, such material has often been transferred and stored in special depository sites. However, due to the more and more limited available space for such sites, such storage has become less attractive. Furthermore, due to environmental reasons associated with the hazardous nature of bitumen and/or asphalt ingredients, many governmental provisions restrict or disallow such storage solutions.

Therefore, the most commonly applied approach is to collect the asphalt and/or bitumen containing excavated material at the construction site and then to transport it to a first facility where it is crushed to provide asphalt and/or bitumen containing debris. Optionally, in the first facility, a coarse material is separated from the remaining parts of asphalt and/or bitumen containing debris. Such coarse material is due to the separation process typically essentially free of asphalt and/or bitumen. The remaining part of asphalt and/or bitumen containing debris still amounts to around 50% of the asphalt and/or bitumen containing excavated material collected at the construction site and is then most commonly transported to a special facility in which this material is chemically and thermally treated to further separate the asphalt and/or bitumen from the bulk materials. One disadvantage of this approach is that such special facilities are scarce and thus the collected material has to be transported over long distances which is neither cost efficient, nor environmentally desired. Furthermore, due to the applied chemical and thermal treatment, the binding agents are often lost. Additionally, with such processes there is still a discard ratio of around 50%, i.e. around 50% of the incoming material is lost in some of today's regeneration processes.

### SUMMARY OF THE INVENTION

It is therefore the general object of the present invention to advance the state of the art in the field of regeneration of asphalt and/or bitumen containing debris and preferably to overcome the disadvantages of the prior art fully or partly. In advantageous embodiments, a method for regenerating asphalt and/or bitumen containing debris is provided, which is more efficient, particularly which allows to recycle more bulk material and optionally binding agents and/or which is more cost efficient and/or environmentally friendly. In further advantageous embodiments, transports over long distances, such as several hundreds or even thousands of kilometers, are avoided.

In a first aspect, the invention relates to a method for regenerating asphalt and/or bitumen containing debris, respectively for regenerating excavation material containing asphalt and/or bitumen. The method comprises the steps:
a. Providing a crushed composition of asphalt and/or bitumen containing debris. Such a crushed composition may be directly obtained from a construction site or by a specific embodiment of the invention as outlined below.
b. Dividing the crushed composition of step a. into a first slurry of sand graining in water and a coarse graining composition by washing the crushed composition of step a. with water. Thereby, a first slurry of sand graining in water and a separated therefrom coarse graining composition is formed. The coarse graining composition typically comprises less water than the first slurry. In particular, the coarse graining composition may be a paste-like composition. It is understood that the first slurry comprises sand graining and water. Furthermore, the coarse graining composition comprises a coarse graining. The coarse graining has a grain size which is larger than the sand of the first slurry.
c. Feeding the coarse graining composition into a washer, in particular into a log washer.
d. Dividing the coarse graining composition in the washer into a second slurry of sand graining in water and a coarse graining by washing the coarse graining composition with water. Thereby, the second slurry of sand graining in water and the coarse graining is formed. The coarse graining is then typically free of bitumen and/or asphalt.
e. Feeding the first slurry of sand graining in water and optionally also the second slurry of and graining in water, into a separator and dividing the first and second slurry of sand graining into a slurry of slit graining in water, and sand graining. The sand graining has a larger grain size than the slit graining. The separator may for example be a hydrocyclone, i.e. a cyclone for separating solids from a bulk fluid, in this case water. Typically, the sand graining is free of bitumen and/or asphalt.
f. Feeding the slurry of slit graining in water of step e. into a water extractor unit, and removing water from the slurry of slit graining and forming a slit graining composition comprising slit graining and bitumen and/or asphalt. It is understood that removing of water occurs in the water extractor unit.

The method according to the invention provides on the one hand a recycled bitumen and/or asphalt free coarse graining and additionally recycled bitumen and/or asphalt free sand graining. A significantly higher amount of the provided crushed composition of asphalt and/or bitumen containing debris is bitumen and/or asphalt free and thus recycled, as compared to known methods, while only the remaining slit graining composition still contains asphalt and/or bitumen and is thus unrecycled.

In some embodiments, step b. may comprise a separation step in which the first slurry of sand graining in water is separated from the coarse graining composition. This may for example be done by sieving. As the coarse graining composition has a larger grain size than the sand graining, sieving can separate these two components from each other.

Typically, step b. is at least partially, or in some embodiments completely, performed within the washer.

In some embodiments, step d. may comprise a separation step in which the second slurry of sand graining in water is separated from the coarse graining. This may for example be done by sieving. As the coarse graining has a larger grain size than the sand graining, sieving can separate these two components from each other. Sieving may for example be performed in the washer and/or as a separate step downstream of the washer, i.e. outside of the washer.

In some embodiments, the coarse graining formed in step d. is thereafter sieved into different groups having different grain sizes.

In some embodiments, steps a. to f. are all performed at the same location, that is within at most 5 km, in particular within at most 1 km. Therefore, it is not necessary to transport the corresponding material between different sites.

In some embodiments steps a. to f. are conducted directly after one another.

In some embodiments, the water extractor unit of step f. may be a filter press and removing water from the slurry is performed by pressing the slurry of slit graining to form a filter cake of the slit graining composition. Typically, the slurry of slit graining is compressed such that at least 90 wt. % of the water are removed. Alternatively, the water extractor unit may be a distillation unit in which water is removed from the slurry by distillation.

As outlined above, the grain size, respectively the median grain size, of the coarse graining is larger than the grain size, respectively the median grain size, of the sand graining. Furthermore, the grain size, respectively the median grain size, of the sand graining is larger than the grain size, respectively the median grain size, of the slit graining.

In some embodiments, the grain size of the coarse graining is between 4 mm and 32 mm, in particular of 4 mm and 22 mm, and/or the median grain size of the coarse graining is between 4 mm and 22 mm, in particular between 10 mm to 25 mm, in particular between 10 mm and 20 mm.

In some embodiments, the grain size of the sand graining is between >0 mm and 6 mm, in particular between >0 mm and 4 mm, and/or the median grain size of the sand graining is between 0.045 mm to 6 mm, in particular between 0.05 mm and 2 mm. The indication >0 mm generally means that 0 mm is not included in the range, i.e. that for example the sand graining may have a grain size of up to 6 mm, in particular of up to 4 mm.

In some embodiments, the grain size of the slit graining is between >0 mm and 0.063 mm and/or the median grain size of the coarse graining is between 0.045 mm to 1 mm, in particular between 0.045 mm and 0.05 mm.

In some embodiments, the sand graining obtained in step e. is further divided into fine sand graining and coarse sand graining. It is understood that the grain size, respectively the median grain size, of the coarse sand graining is larger than the grain size, respectively the median grain size, of the fine sand graining. For example, the fine sand graining may have a grain size of between 0.063 mm to 1 mm and/or a median grain size of 0.1 mm to 0.8 mm, in particular of 0.1 mm to 0.5 mm. The coarse sand graining may have a grain size of between >1 mm and 6 mm, in particular >1 mm and 4 mm and/or a median grain size of 2 mm to 5 mm, in particular of 3 mm to 4 mm.

The skilled person knows that the grain size as it is used herein can be determined by sieving with sieves of different mesh sizes, i.e. by sieve analysis. The median grain size is the determined grain size from which half of the particles are smaller and half are larger. The median grain size may for example be determined from a grain size distribution curve.

Furthermore, the term “free of bitumen and/or asphalt” as used herein refers to a bitumen and/or asphalt content of 1 wt. % or less, in particular of 0.5 wt. % or less.

In some embodiments, the method further comprises step g1. Step g1 comprises disposing the slit graining composition of step f. Disposing the slit graining composition may in some examples comprise burning of the slit graining composition. As the major amount of material has already been recycled as sand graining or coarse graining, such an approach is more efficient as only a minor part of the original debris is burned together with the unrecycled bitumen and/or asphalt.

In some embodiments, the method comprises step g2. Step g2 comprises removing the asphalt and/or bitumen from the slit graining composition thereby forming a recycled filler composition having a lower asphalt and/or bitumen concentration than the slit graining composition of step f. Preferably, the recycled filler composition is free of asphalt and/or bitumen. Such embodiments are particularly advantageous as even the slit graining and optionally also the binding agents, i.e. the asphalt and/or bitumen, can be recycled. It is understood that step g2 may be performed alternatively to step g1.

In some embodiments, steps a. to f. and also g1 or g2 are all performed at the same location, that is within at most 5 km, in particular within at most 1 km. Therefore, it is not necessary to transport the corresponding material between different sites.

It is understood that the recycled filler composition comprises or consists of filler graining. Filler graining has a smaller grain size, respectively a smaller median grain size, than the sand graining. In particular embodiments, filler graining may have a grain size of less than 0.063 mm.

In some embodiments, step g2 comprises suspending the slit graining composition of step f. in a solvent, in particular an organic solvent, and extracting the asphalt and/or bitumen to form a continuous phase comprising the solvent and the recycled filler composition. The recycled filler composition is typically suspended in the continuous phase. After extraction, the continuous phase comprises the solvent and extracted asphalt and/or bitumen. The organic solvent may for example be or comprise a hydrocarbon. The hydrocarbon may for example be a mineral oil. For example, the organic solvent may be pentane, hexane, heptane, octane, cyclohexane, cycloheptane, cyclooctane, toluene, and the like, or a halogenated hydrocarbon solvent, such as dichloromethane, chloroform and the like, or mixtures thereof. It is understood that during such a process, the solvent extracts the bitumen and/or asphalt from the slit graining composition. Thus, the solvent is selected such that it can dissolve asphalt and/or bitumen, in particular at 20° C. and 1 atm. The solvent used in this step, i.e. for suspending and extraction may be a first solvent and the formed continuous phase a first continuous phase. Typically, the majority, or >80 wt. %, >90 wt. %, >95 wt. % or even all of the asphalt and/or bitumen of the slit graining composition of step f. is present in the continuous phase.

Suspending the slit graining composition in a solvent may be performed in a reactor. The reactor may preferably be equipped with a stirrer. During suspending and extraction, the mixture is typically stirred by the stirrer.

In some embodiments, suspending the slit graining composition in the solvent, in particular and extracting the asphalt and/or bitumen is performed under heating, i.e. at temperatures higher than room temperature, in particular up to or at the boiling point of the selected solvent.

In some embodiments, the recycled filler composition is separated from the continuous phase. Such a separation may be performed by filtration, sedimentation or by centrifugation.

In some embodiments, separation of the recycled filler composition from the first continuous phase is performed at the same location as steps a. to f. and optionally step g2, that is within at most 5 km, in particular within at most 1 km. Therefore, it is not necessary to transport the corresponding material between different sites.

In some embodiments, the separated recycled filler composition is washed with a solvent, in particular another solvent to form a washed recycled filler composition and a therefrom separated second continuous phase. This solvent may thus be a second solvent being different from the first solvent (i.e. the solvent used for suspending the slit graining composition and extracting the asphalt and/or bitumen). The second solvent is typically selected such that it is miscible with the first solvent, i.e. at 20° C. and 1 atm. This washing step serves to remove remaining amounts of the first solvent and/or any remaining asphalt and/or bitumen. This is particularly favorable if the first solvent is a hydrocarbon and thus relatively harmful to the environment. The second solvent may preferably be more environmentally friendly. Preferably, the second solvent is an alcohol, such as methanol, ethanol or iso-propanol.

In a subsequent step (i.e. after washing), the washed recycled filler composition is dried by a dryer unit, thereby evaporating residuals of the second solvent.

In some embodiments, washing and optionally drying is performed at the same location as steps a. to f. and optionally step g2, that is within at most 5 km, in particular within at most 1 km. Therefore, it is not necessary to transport the corresponding material between different sites.

In some embodiments, the second continuous phase formed during washing may comprise a portion of the recycled filler composition. The second continuous phase may thus be filtered to separate the portion of the recycled filler composition from the remaining part of the second continuous phase. This separated portion of the recycled filler composition may also be dried by the dryer unit.

The second continuous phase, respectively the remaining part of the second continuous phase after filtering may in some embodiments be combined with the first continuous phase, i.e. the continuous phase from suspending the slit graining composition in the solvent, in particular and extracting the asphalt and/or bitumen.

In some embodiments, the continuous phase, i.e. the first continuous phase, is recycled by a distillation after the extraction, thereby regenerating the solvent, i.e. the first solvent, and the therefrom separated asphalt and/or bitumen. In some embodiments, the second continuous phase, respectively the remaining part of the second continuous phase after filtering is recycled by a distillation after the extraction, thereby regenerating the second solvent and the therefrom separated asphalt and/or bitumen. In some embodiments, the combined first continuous phase and the second continuous phase, respectively the remaining part of the second continuous phase after filtering are recycled by a distillation after the extraction, thereby regenerating the first solvent, the therefrom separated second solvent and the therefrom separated asphalt and/or bitumen. In all these embodiments, the distillation may preferably be a vacuum distillation or a flash distillation. Such recycling processes are beneficial, as not only the solvent(s) can be reused, but also the bitumen and/or asphalt is recycled.

In some embodiments, the recycling of the continuous phase is a distillation being performed at the same location as steps a. to f. and optionally g2, that is within at most 5 km, in particular within at most 1 km. Therefore, it is not necessary to transport the corresponding material between different sites.

In some embodiments, the distillation comprises a first distillation step at a first temperature and a subsequent second distillation step at a second temperature, wherein the second temperature is higher than the first temperature. For example, the first temperature may be selected such that water and optionally solvent with a boiling point lower or equal to the boiling point of water is removed. The second temperature may be selected such that organic compounds, for example solvents or bitumen and/or asphalt components, is removed. In some embodiments, the temperature difference between the first temperature and the second temperature may be between 50° C. and 200° C., in particular between 70° C. and 120° C. For example, the first temperature may be 100° C. to 130° C. and the second temperature may be 170° C. to 220° C.

In some embodiments, the first distillation step and/or the second distillation step may be a vacuum distillation step, i.e. a distillation which is performed at sub-atmospheric pressure.

In some embodiments, during the distillation a combustion gas is separated. The separated combustion gas is further used as an energy source for the distillation. The combustion gas may comprise combustible components of the bitumen and/or asphalt or derivatives thereof. Separating such a combustion gas and using it as an energy source makes the overall process more energy efficient.

The combustion gas may for example be separated in an individual third distillation step or together with the first and/or second distillation step.

In some embodiments, the crushed composition asphalt and/or bitumen containing debris provided in step a. has a grain size of 32 mm or less, in particular of 25 mm or less, in particular of 22 mm or less; and/or the sand graining of the first and/or the second slurry has a grain size of 5 mm or less, in particular of 4 mm or less; and/or the coarse graining of step d. has a grain size of between >4 mm and 32 mm, in particular of >4 mm and 22 mm.

In some embodiments, step a. comprises sub-step a1 and optionally sub-step a2. Sub-step a1 comprises feeding excavation material into a crushing device, such as a first impact crushing device, and crushing the excavation material within the first impact crushing device to provide the crushed composition of asphalt and/or bitumen containing debris. The excavation material may be material which is directly obtained from a construction site, such as a road construction and comprises bitumen and/or asphalt containing debris. An impact crushing device is a device in which the material impacts on both parts of the device, but also collides with itself. Thereby, friction and impact forces are exerted, which crush the excavation material. Preferably a vertical impact crushing device may be used. Such vertical impact crushers are configured such that the excavation material is accelerated by centrifugal force by a rotor against an outer ring of the crusher, and then fractures.

Optional sub-step a2 comprises feeding the crushed excavation material obtained in step a1 into a sieving unit and sieving the crushed excavation material, thereby preferably providing a crushed composition of asphalt and/or bitumen containing debris with a grain size of 22 mm or less. In some embodiments, step a1 may be dispensed with and the excavation material from a construction site is directly fed into the sieving unit according to step a2, in particular to provide the crushed composition of asphalt and/or bitumen containing debris with a grain size of 22 mm or less. In some embodiments, the sieving unit is configured for dividing, respectively divides, the crushed excavation material being fed into the sieving unit into three groups having three different grain sizes. The first group having the largest grain size, i.e. which may be between 4 and 22 mm, may in particular be fed back into crushing device for repeated crushing. The second group having an intermediate grain size of 4 to 22 mm may be used further in step b. as the crushed composition. The third group having a grain size of >0 to 4 mm may for example be collected separately as a sand graining. The second group may in particular have a median grain size of 10 mm to 25 mm, in particular 10 mm and 20 mm. The third group may in particular have a median grain size of 0.045 mm to 6 mm, in particular between 0.05 mm and 2 mm. The first group may have a median grain which is larger than the median grain size of the second group, such as 30 mm or more, or 40 mm or more.

In some embodiments, crushing the excavation material comprises a mechanic purification during which impact forces and friction forces purify the excavation material and/or the crushed excavation material.

In some embodiments, the crushed excavation material of step a1, or step a2 is crushed in a further, second crushing step. The second crushing step is preferably performed in a vertical impact crushing device, for example, a vertical impact device as described above. In some embodiments, steps a1 and a2 may be dispensed with and the excavation material from a construction site is directly fed into the vertical impact device as described above for the second crushing step, in particular to provide the crushed composition of asphalt and/or bitumen containing debris.

In some embodiments, the vertical impact crushing device in the second crushing step is operated at a rotational speed of 40 m/s to 60 m/s.

In some embodiments, the crushed excavation material is fed into the vertical impact crushing device for the second crushing step with a rate of 50 t/h to 150 t/h.

In some embodiments, the slit graining composition obtained in step f. comprises a ratio of asphalt and/or bitumen to slit graining of between 5:95 to 40:60, in particular of between 10:90 to 30:70.

Another aspect of the invention relates to a use of coarse graining obtained in step d. of claim 1 and/or sand graining obtained in step e. of the method according to the first aspect of the invention and/or of slit graining obtained in step f. of the method according to the first aspect of the invention and/or the recycled filler composition obtained in step g2 of the method according to the first aspect of the invention and/or the washed recycled filler obtained by embodiments method according to the first aspect of the invention as construction material, for example as a construction material in road construction.

Another aspect of the invention relates to a use of asphalt and/or bitumen separated from solvent during the distillation as described in some embodiments of the first aspect of the invention.

### BRIEF DESCRIPTION OF THE DRAWINGS

The herein described invention will be more fully understood from the detailed description given herein below and the accompanying drawings which should not be considered limiting to the invention described in the appended claims. The drawings are showing:

FIG. 1 a schematic representation of a method according to an embodiment of the invention;

FIG. 2 a schematic representation of certain steps according to some embodiments of the invention.

### DETAILED DESCRIPTION OF THE INVENTION

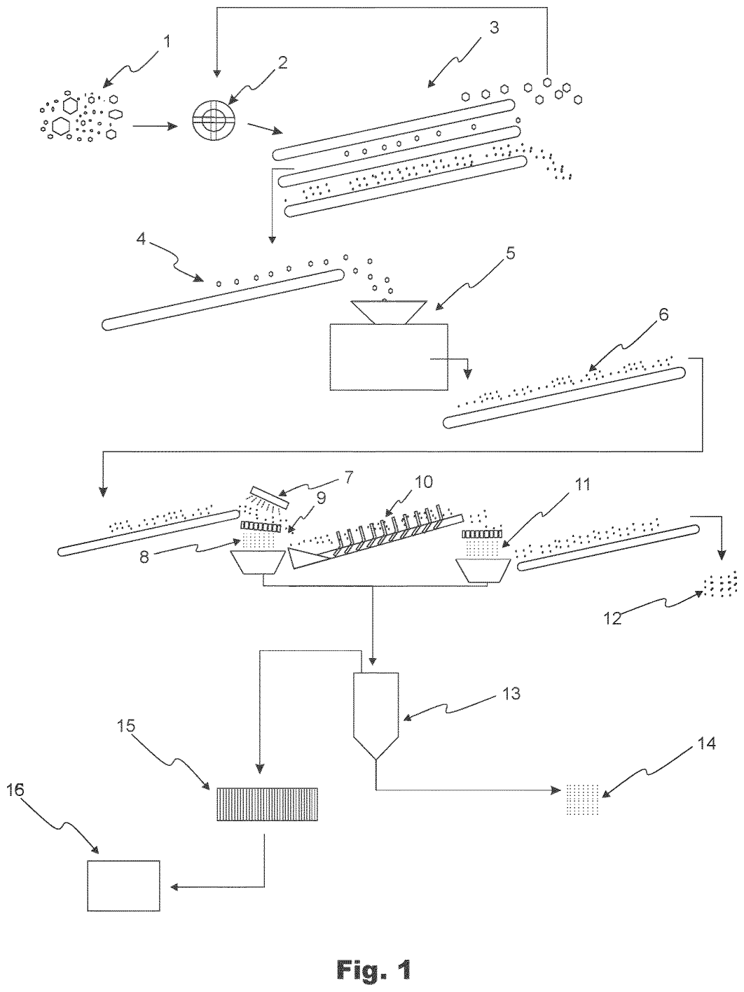

FIG. 1 shows schematically an embodiment of the method for regenerating asphalt and/or bitumen containing debris. The asphalt and/or bitumen containing debris may originate from excavation material 1, which may originate directly from a construction site, for example from a road demolition. It is characterized by having various differently sized particles. In a first optional step, the excavation material may be crushed by a crushing device 2 in order to crush the excavation material such that its grain size is reduced (Step a1). In a second optional step (Step a2), the crushed excavation material is fed into sieving unit 3 in which it is sieved to provide crushed excavation material 4. The sieving unit may in this or any other embodiment be configured for dividing the crushed excavation material being fed into the sieving unit into three or more groups having different grain sizes. The first group having the largest grain size, i.e. which may be between 4 and 22 mm, may in particular be fed back into crushing device 2 for repeated crushing. The second group having an intermediate grain size of 4 to 22 mm may be used further as crushed and sieved excavation material 4. The third group having a grain size of >0 to 4 mm is collected separately as a sand graining. In a third optional step, the crushed and sieved excavation material is thereafter crushed in a further, second crushing step which is performed in vertical impact crushing device 5 to provide a crushed composition of asphalt and/or bitumen containing debris 6.

Then, the crushed composition of asphalt and/or bitumen containing debris 6 is divided into first slurry 8 of sand graining in water and a therefrom separated coarse graining composition 9. Water may be provided via water unit 7, which may be a nozzle. This separation step is achieved by washing crushed composition of asphalt and/or bitumen containing debris 6 with water and generally a separation step, which may in this or any other embodiment preferably be achieved by sieving. The sand graining of the first slurry 8 has smaller grain size than the coarse graining composition 9. The latter is then fed into log washer 10, in which it generally washed, which results in the formation of a second slurry of sand graining in water 11. The second slurry 11 of sand graining in water is separated as described above from the resulting coarse graining 12, which is essentially free of bitumen and/or asphalt and which may be reused for construction. The sand graining of the second slurry and also the sand graining of 15 the first slurry have a smaller grain size then the grain size of coarse graining 12.

First slurry 8 and second slurry 11 are then combined and fed into hydrocyclone 13, in which the combined first and second slurry of sand graining in water is divided into a slurry of slit graining in water and sand graining 14. Sand graining 14 is essentially free of water, i.e. dry and also essentially free of asphalt and/or bitumen. Furthermore, the grain size of sand graining 1 is smaller than of the slit graining.

The slurry of slit graining is then fed into water extractor unit 15, which may for example be a filter press. In the water extractor unit, the slurry of slit graining is divided into removed water and a slit graining composition. The slit graining composition may in general in this and any other embodiment described herein be dry, i.e. essentially free of water. The slit graining composition comprises slit graining and bitumen and/or asphalt. This slit graining composition may then be further recycled as described further above, for example in an extraction unit 16 in which the slit graining composition is suspended in a solvent and the asphalt and/or bitumen is extracted to form a continuous phase comprising the solvent and the recycled filler composition.

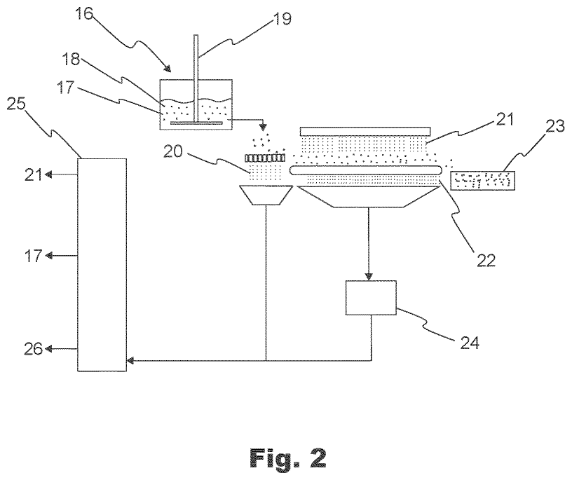

FIG. 2 shows how the slit graining composition obtained in step f. can further be recycled and purified. The slit graining composition 18 is suspended in first solvent 17 in a reactor being equipped with stirrer 19. This suspension is after a certain predefined extraction time separated into first continuous phase 20 and the recycled filler composition. The recycled filler composition is then washed with second solvent 21, being different from first solvent 17 but miscible with it to form a washed recycled filler composition which can be dried in dryer unit 23 and therefrom separated second continuous phase 22. Second continuous phase may contain certain amounts of the washed recycled filler composition and may thus be separated therefrom in separator unit 24, which may for example be a filter. First continuous phase 20 and second continuous phase 22, respectively the remaining part of second continuous phase 22 after separation, may then be transported to distillation unit 25. In distillation unit 25, a distillation is performed resulting in separated asphalt and/or bitumen 26, separated first solvent 17 and separated second solvent 21.

### REFERENCE SIGNS

1 excavation material
2 crushing device
3 sieving unit
4 crushed excavation material
5 vertical impact crushing device
6 asphalt and/or bitumen containing debris
7 water unit
8 first slurry
9 coarse graining composition
10 log washer
11 second slurry
12 coarse graining
13 hydrocyclone
14 sand graining
15 water extractor unit
16 extraction unit
17 first solvent
18 slit graining composition
19 stirrer
20 first continuous phase
21 second solvent
22 second continuous phase
23 dryer unit
24 separator unit
25 distillation unit
26 asphalt and/or bitumen

1. A method for regenerating asphalt and/or bitumen containing debris, the method comprising the steps of:
a. providing a crushed composition of asphalt and/or bitumen containing debris;
b. dividing the crushed composition of step a. into a first slurry of sand graining in water and a coarse graining composition by washing the crushed composition of step a. with water, thereby forming the first slurry of sand graining in water and the coarse graining composition;
c. feeding the coarse graining composition into a washer, in particular a log washer;
d. dividing the coarse graining composition in the washer into a second slurry of sand graining in water and a coarse graining by washing the graining composition with water thereby forming the second slurry of sand graining in water and the coarse graining;
e. feeding the first slurry of sand graining in water and optionally the second slurry of sand graining in water, into a separator, in particular a hydrocyclone, and dividing the first and second slurry of sand graining into a slurry of slit graining in water and sand graining;
f. feeding the slurry of slit graining in water of step e. into a water extractor unit and removing water from the slurry of slit graining and forming a slit graining composition comprising slit graining and bitumen and/or asphalt.

2. The method according to claim 1, further comprising step g1: disposing the slit graining composition of step f., in particular by burning the slit graining composition; or further comprising step g2: Removing asphalt and/or bitumen from the slit graining composition, thereby forming a recycled filler composition having a lower asphalt and/or bitumen concentration than the slit graining composition of step f.

3. The method according to claim 2, wherein step g2 comprises suspending the slit graining composition in a first solvent and extracting the asphalt and/or bitumen to form a first continuous phase which comprises the first solvent, and the recycled filler composition.

4. The method according to claim 3, wherein the recycled filler composition is separated from the first continuous phase, in particular by centrifugation or filtration.

5. The method according to claim 4, wherein the separated recycled filler composition is washed with a second solvent being different from the first solvent to form a washed recycled filler composition and a therefrom separated second continuous phase.

6. The method according to claim 3, wherein the first continuous phase and/or the second continuous phase is recycled by a distillation, thereby regenerating the first solvent and/or the second solvent and the therefrom separated asphalt and/or bitumen.

7. The method according to claim 6, wherein the distillation comprises a first distillation step at a first temperature and a subsequent second distillation step at a second temperature, wherein the second temperature is higher than the first temperature.

8. The method according to claim 6, wherein during the distillation a combustion gas is separated, and wherein the separated combustion gas is used as an energy source for the distillation.

9. The method according to claim 1, wherein the crushed composition of asphalt and/or bitumen containing debris provided in step a. has a grain size of 25 mm or less, in particular of 22 mm or less; and/or wherein the sand graining of the first and/or the second slurry has a grain size of 5 mm or less, in particular of 4 mm or less; and/or wherein the coarse graining of step d. has a grain size of between >4 mm and 32 mm, in particular of >4 mm and 22 mm.

10-15. (canceled)

16. The method according to claim 1, wherein step a. comprises:
a1. feeding excavation material into a crushing device, in particular into an impact crushing device, and crushing the excavation material within the crushing device; and optionally
a2. feeding the crushed excavation material into a sieving unit and sieving the crushed excavation material to provide the crushed composition of asphalt and/or bitumen containing debris.

17. The method according to claim 16, wherein crushing the excavation material comprises a mechanic purification during which impact forces and friction forces purify the excavation material and/or the crushed excavation material.

18. The method according to claim 16, wherein the crushed excavation material is crushed in a further, second crushing step, wherein the second crushing step is preferably performed in a vertical impact crushing device.

19. The method according to claim 18, wherein the second vertical impact crushing device is operated at a rotational speed of 40 m/s to 60 m/s.

20. The method according to claim 18, wherein the crushed excavation material is fed into the vertical impact crushing device with a rate of 50 t/h to 150 t/h.

21. The method according to claim 1, wherein the slit graining composition obtained in step f. comprises a ratio of asphalt and/or bitumen to slit graining of between 5:95 to 40:60, in particular of between 10:90 to 30:70.
